(19) United States
(12) Patent Application Publication
(10) Pub. No.: US 2005/0155389 A1
(43) Pub. Date: Jul. 21, 2005

(54) Optical fiber production system and crosshead die therefor

(76) Inventors: David Losan Ho, Beijing (CN); Lianxun Feng, Beijing (CN); Liqun Dong, Beijing (CN); Xinhou Liu, Beijing (CN); Zhen Zhen, Beijing (CN)

Correspondence Address: PERKINS COIE LLP, POST OFFICE BOX 1208, SEATTLE, WA, 98111-1208, US

(21) Appl. No.: 10/883,638

(22) Filed: Jun. 30, 2004

Related U.S. Application Data
(63) Continuation of application No. PCT/US02/41511, filed on Dec. 27, 2002.
(60) Provisional application No. 60/345,795, filed on Dec. 31, 2001.

(51) Int. Cl. C03B 37/02

(52) U.S. Cl. 65/401; 264/172.15; 425/112; 425/113; 425/133.1

(57) ABSTRACT

A crosshead die for a plastic optical fiber fabrication system is provided. The crosshead die includes a body, an insert, mounting flanges on the upstream and downstream end for securing the crosshead die to adjacent equipment or another crosshead dies, an axial port for receiving a mixed molten material that makes up the core, and a radial port for receiving a mixed molten material that makes up the outer layering material to be co-extruded over the core. The die insert includes a material distribution channel system that provides substantially the same linear distance for the mixed molten material to travel prior to the co-extrusion. If multiple die inserts are utilized, the crosshead die is able to co-extrude multiple layers over the core. If the crosshead dies are serially assembled, additional concentric layers of material can be co-extruded atop the layered plastic optical fiber extruded from the upstream crosshead die.

### FIELD OF THE INVENTION

The field of the present invention relates to extruders, crosshead dies for extruders, and methods of manufacturing plastic optical fibers using a crosshead die.

### BACKGROUND

Glass optical fiber is a major transmission medium in high capacity long distance communication applications. Glass optical fiber, however, has not found significant usage in smaller applications, such as local area network applications, because, among other things, glass optical fiber suffers from poor mechanical properties, high production costs, and labor-intensive fiber splicing techniques. There has been interest, therefore, in plastic optical fiber (POF) having a large core diameter, to ease the splicing thereof, that offers many of the benefits of glass optical fiber, but is more cost effective to produce and process.

Generally, there are two types of POFs: a step-index POF (SI POF) and a graded-index POF (GI POF). A SI POF may be characterized by a radial index of refraction which is essentially a step function. A GI POF may be characterized by a radial index of refraction that non-linearly varies from the center of the fiber to the perimeter.

Regardless of which type of POF, prior fabrication schemes involved some form of concentric application of materials having different refractive indices to produce SI POF or GI POF. One method involves producing a preform by chemical vapor deposition and varying the refractive index modifier during the deposition to yield the desired refractive index profile. The preform is subsequently drawn to the desired fiber diameter. Although this method yields a working POF, such a method is time-consuming and not conducive to commercial production rates and demands.

An alternative method involves extruding layers of different spinning materials through a concentric nozzle. A typical concentric nozzle includes a radial port in fluid communication with an extruder on one end and an annulus on the other end. The annulus feeds into a conical clearance created by two conical surfaces which delivers the molten spinning material in a concentric form to an annular exit port. At or near the annular exit port is the exit port for a core extruding along the central axis of the conical surfaces. In such a way, a concentrically layered POF is extruded through the concentric nozzle. This arrangement, however, is inadequate to ensure proper flow of the spinning material from the extruder to the nozzle's annular exit port. In particular, pressure gradients due to uneven material distribution often cause circumferential inconsistencies in the flow rate resulting in thickness variations in the layers of the extruded composite fiber.

Further, where it is desirable to apply four or more layers, machining and tool fabrication limitations of dies and nozzles prevent adequately controlling the tolerances needed to extrude a sufficiently concentrically layered fiber having an adequately controlled layer thickness.

Therefore, it is desirable, among other things, to have an extruding method and apparatus which significantly eliminates circumferential pressure gradients for a concentric configuration plastic optical fiber and that which effectively and flexibly facilitates extruding a concentrically multi-layered plastic optical fiber for commercial production application.

### SUMMARY OF THE INVENTION

In a preferred embodiment of the invention, a crosshead die capable of co-extruding a concentrically configured plastic optical fiber including a layering material over a core material is provided. The crosshead die includes a body and a die insert. The die insert includes a through bore for extruding the core and a distribution channel system for distributing the layering material that is to be extruded over the core. The distribution channel system facilitates unwanted pressure drops from developing as the layering material flows to the annular exit port thereby preventing unevenness in the extruded layer.

In another preferred embodiment, a crosshead die capable of co-extruding a core and a concentric layer material includes annular buffer rings disposed upstream of the layer material's annular exit port to stabilize or equalize inner stresses often found in plastic material during extrusion through an annular clearance.

In another preferred embodiment, the crosshead die includes multiple die inserts configured to form multiple annular ports that facilitates co-extruding a concentrically multilayered plastic optical fiber having a core and multiple layers applied over the core.

In another preferred embodiment, the crosshead die provides helical channels upstream of the annular exit ports to enhance mixing materials to be extruded.

In another preferred embodiment, the crosshead die provides a layering material flow path that utilizes both helical and axial direction about the surface of the die insert.

In another preferred embodiment, crosshead dies are assembled in series to form a crosshead die set wherein the co-extruded composite fiber that is extruded from a first crosshead die is fed into a second crosshead die which applies additional layers onto the composite fiber. Such a configuration facilitates easily adding, removing or changing concentric layers extruded over a core and reduces the need for a complete teardown of the fiber production system.

Further objects, features, and advantages of the invention will be better understood from the following description considered in connection with the accompanying drawings in which various embodiments of the invention are illustrated by way of example.

### BRIEF DESCRIPTION OF THE DRAWINGS

FIG. 1 illustrates a fiber production system according to the present invention.

FIG. 2 illustrates a partial cross-sectional view of a crosshead die.

FIG. 3 illustrates a cross-sectional view of a body of the crosshead die of FIG. 2.

FIG. 4 illustrates a cross-sectional view of a die insert of the crosshead die of FIG. 2.

FIG. 5 illustrates a partial cross-sectional view of an alternate crosshead die.

FIG. 6 illustrates a partial cross-sectional view of an outer die insert of the alternate crosshead die of FIG. 5.

FIG. 7 illustrates a side view of two crosshead dies assembled in series.

FIG. 8 illustrates a two dimensional perspective of the distribution channel system from View A-A.

FIG. 9 illustrates a two dimensional perspective of an alternate distribution channel system.

FIG. 10 illustrates a cross sectional view of a crosshead die to show yet another alternate distribution channels system.

FIG. 11 illustrates an alternate fiber production system.

### DETAILED DESCRIPTION OF THE PREFERRED EMBODIMENTS

Preferred embodiments will now be described with reference to the drawings. To facilitate description, any reference numeral representing an element in one figure will represent the same element in any other figure.

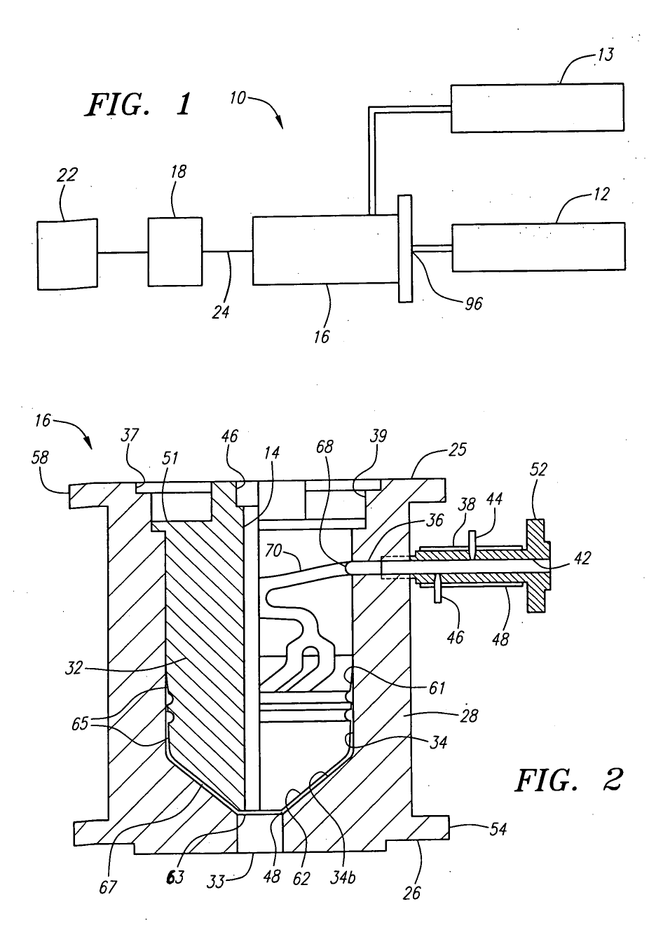

FIG. 1 illustrates a fiber production system 10 comprising a first extruder 12, a second extruder 13, a crosshead die 16, a fiber drawing device 18 and fiber collection device 22.

In operation, a first material, commonly in pebble or powder form, is introduced to extruder 12 where it is melted and mixed to a desired consistency and temperature. Similarly, a second material, commonly in pebble or powder form, is introduced to extruder 13 to produce a mixed molten second material. The first and second material in their introduced form may be a polymer that is pre-mixed with additives, dopants or other materials that may affect their respective refractive index. Alternatively, the first and second material, when introduced to extruders 12, 13, respectively, may be in a non-polymerized, commonly, liquid form. In this arrangement, the additives, dopants or other materials that may affect the refractive index may be added into the respective extruders directly. Either way, the first and second material may or may not be the same polymer. The refractive indices of the two materials, however, are preferably different.

Regardless of the form in which the first and second materials are introduced and the manner in which they are prepared into the mixed molten state, the two materials are then fed into the crosshead die 16 wherein a composite fiber 24 is extruded therefrom. The extruded composite fiber 24 has a concentrically layered configuration which is then drawn by a fiber drawing device 18 and collected by the fiber collection device 22. In this way, a concentrically layered POF is fabricated having a first material core and a second material outer layer.

Extruders 12, 13 suitable for use in the fiber production system 10 described above may be any, often commercially available, extruder that is capable of mixing the material to the desired consistency and temperature. The fiber drawing device 18 may be a capstan or other suitable device capable of drawing a fiber to the desired diameter. The fiber collection device 22 may be a spool or other suitable device for collecting the fiber.

A first embodiment crosshead die 16 according to the present invention will now be described in greater detail. The crosshead die 16 includes an upstream end 25, a downstream end 26, a body 28, a die insert 32 and an adapter 38 as illustrated in FIG. 2. The upstream end 25 includes a mounting flange 58 for engagement with other equipment or devices as necessary. Similarly, the downstream end 26 includes a mounting flange 54 for engagement with other equipment or devices as necessary.

The body 28, shown individually in FIG. 3, includes a constant diameter through hole 33, an interior surface 34—which has a generally cylindrical portion 34a and a conical section 34b, an exterior surface 35, a radial bore 36, the downstream mounting flange 54 and the upstream mounting flange 58. The radial bore 36 extends from the interior surface 34 to the exterior surface 35. The downstream mounting flange 54 includes bolt-holes 27 and a cylindrical alignment plug 56. The upstream mounting flange 58 includes bolt-holes 29, a counterbore 37, and an insert support bore 39. The radial bore 36 of the body 28 may be threaded for receiving the adapter 38.

Referring to FIG. 2, the adapter 38 includes a through hole 42, a temperature sensor port 44, a pressure sensor port 46, a heater 48, and flange connector 52. The flange connector 52 is configured to connect to an extruder in conventional fashion. The temperature sensor port 44 and pressure sensor port 46 are configured to accept standard sensors. The heater 48 may be any conventional heating device such as electric coils. By this configuration, the adapter 38 facilitates measuring parameters necessary to fine control the temperature and pressure throughout the extruding process.

Although an adapter 38 is shown assembled to the crosshead die 16, it is not necessary to have an adapter 38. In an alternate embodiment, the radial bore 36 may be configured to directly interface with an extruder without the adapter 38.

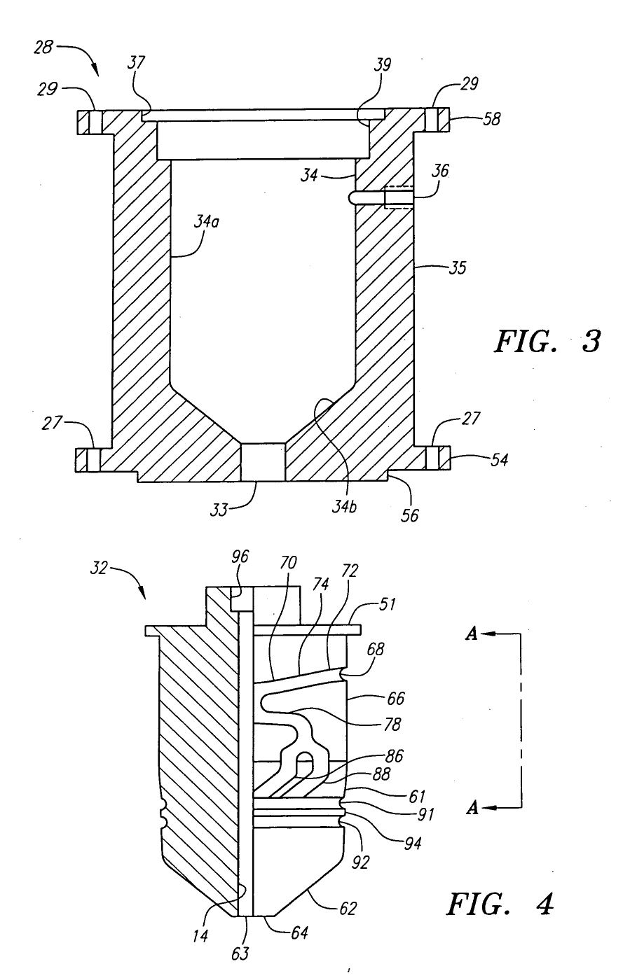

Turning now to FIG. 4, the die insert 32 will be described. The die insert 32 includes a through axial hole 14, an inlet port 96, a forward end 64, a generally conical surface 62, a frustoconical segment 61, a generally cylindrical surface 66, and an insert flange 51. The conical surface extends from the forward end 64 to the frustoconical segment 61. Further on the exterior surface, the die insert 32 includes a receiving cavity 68, a distribution channel system 70, a first buffer ring 91, and a second buffer ring 92.

The distribution channel system 70 includes a system of channels disposed on the external cylindrical surface 66 and frustoconical surface 61 and provides paths for the receiving cavity 68 to communicate with the first buffer ring 91. FIG. 8 illustrates the distribution channel system 70, disposed on the external surface of the die insert 32, in a two-dimensional perspective as seen from View A-A of FIG. 4. Since the distribution channel system 70 is generally symmetric about the receiving cavity 68, one half of the distribution channel system 70 will be described and referred herein as distribution channels 72.

Referring to FIGS. 4 and 8, distribution channels 72 include a main channel 74, division channels 76, 78, and feed channels 82, 84, 86, 88. The receiving cavity 68 is located on the external surface 66 of the die insert 32 and is in fluid communication with the distribution channels 72. The main channel 74 travels first in a helical direction and then in an axial direction before splitting into the two division channels 76, 78. Division channel 76 also travels in a helical direction and then in an axial direction before splitting into the two feed channels 82, 84. In the same way, division channel 78 splits into feed channels 86, 88. The feed channels 82, 84, 86 and 88 travel axially then in a helical direction. Feed channels 82, 84, 86 and 88 are in fluid communication with the first buffer ring 91.

The distribution channels 72 arranged as described above is one possible arrangement and is described for exemplary purposes. As described above and illustrated in FIG. 8, the channel arrangement includes a plurality of material distribution paths wherein each path has substantially the same linear distance between the receiving cavity 68 and the first buffer ring 91. However, the distribution channels 72 and distribution channel system 70 according to the present invention may have other arrangements. For example, the feed channels 82, 84, 86 and 88 may be directed in the axial direction without having a helical direction portion.

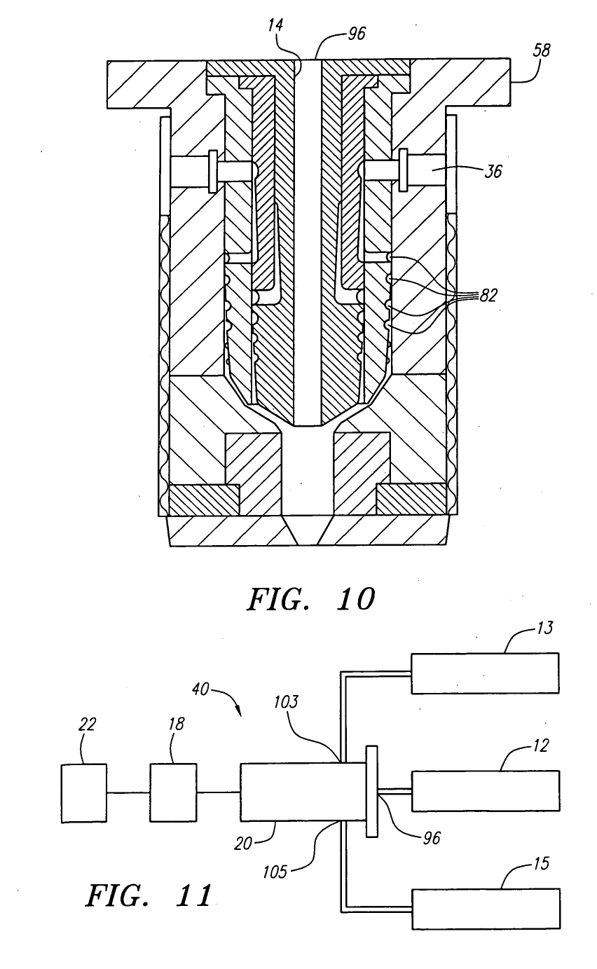

Alternatively, the feed channels 82, 84, 86 and 88 may be arranged such that they travel in a helical direction around the die insert 32 one complete revolution before communicating with the first buffer ring 91 as shown in FIG. 9. In yet another embodiment, a single feed channel 82, among others, may travel numerous times around the crosshead die as shown in FIG. 10. Generally, it is desirable to have the channels travel in the helical direction which enhances mixing of the extruding material as it flows through the channels. The distribution channel arrangement as illustrated in FIGS. 9 or 10 therefore enhances mixing.

Furthermore, although two main, four division and eight feed channels are illustrated in FIG. 8, the distribution channel system 70 may have more or less main channels, division channels, feed channels and/or additional channels to achieve a material feeding system that includes material flow paths each having substantially the same linear distance from the receiving cavity 68 to the first buffer ring 91. For example, each feed channel 82, 84, 86, 88 may further be split into two sub-channels to yield sixteen sub-channels to feed the first buffer ring 91.

Referring back to FIG. 4, the first buffer ring 91 is in fluid communication with the second buffer ring 92. The first buffer ring 91 and the second buffer ring 92 are annular grooves that extend 360° about frustoconical surface 61. In between the first buffer ring 91 and second buffer ring 92 is a bridging surface 94. Bridging surface 94 of the insert die 32 has a diameter smaller than the interior surface 34 of the body 28.

The distribution channels 72, first buffer ring 91, second buffer ring 92 and bridging surface 94 are disposed on the exterior surface of the die insert 32 and may be produced by conventional machining or other suitable methods.

Referring back to FIG. 2, the physical relationship of the assembled crosshead die 16 will now be described. The die insert 32 is inserted into the interior surface 34 of the body 28 and secured thereon by bolts or screws (not shown) through the insert flange 51 and into corresponding threaded holes in the body 28 (not shown) in conventional fashion.

The interior surface 34 of the body 28 is properly sized relative to the die insert's exterior surface 66 and conical surface 62, and insert support bore 39 is properly axially positioned such that when the die insert 32 is secured in place, a constant conical clearance 67 between conical surfaces 34b and 62 is created wherein the clearance extends to an exit annulus 98. Furthermore, when assembled, a gradually increasing clearance 65 is created between the frustoconical surface 61 of the die insert 32 and the cylindrical surface 34b of the body 28.

In the assembled condition, the die insert 32 is oriented such that the receiving cavity 68 aligns with the radial bore 36 of the body 28. Finally, as can readily be seen, once assembled, the interior surface 34 of the body encloses the distribution channel system 70, the first buffer ring 91, the second buffer ring 92 and the bridging surface 94. A clearance between the interior surface 34 of the body and the bridging surface 94 of the insert provides communication between the first buffer ring 91 and the second buffer ring 92.

Assembled this way, the distribution channels 72 form paths for the layering material entering from the receiving cavity 68 to the exit annulus 98. There are two modes for the mixed molten material entering the crosshead die 16 through the radial bore 36 to travel. In the first mode, as described herein for the symmetrical one-half of the distribution channel system 70, the mixed molten material flows through four paths to the buffer rings, and then through the conical clearance 67 and out of the exit annulus 98. The four paths are through 1) main channel 74 to division channel 76 to feed channel 82, 2) main channel 74 to division channel 76 to feed channel 84, 3) main channel 74 to division channel 78 to feed channel 86, and 4) main channel 74 to division channel 78 to feed channel 88. In the second mode, the mixed molten material flows through the main channel 74, to division channels 76, 78 and through the gradually increasing clearance 65. The first mode generally directs the molten material in a helical pattern while the second mode directs the molten material through both a helical and an axial pattern.

Referring now to FIGS. 1 and 2, in use, the first extruder 12 provides a mixed molten material (core material) to the crosshead die 16 through the inlet port 96, and the second extruder 13 provides a mixed molten material (layering material) to the radial bore 36 through adapter 38. The core material travels through the axial bore 14 of die insert 32 and extrudes out of the exit port 63. The layering material travels through the radial bore 36, the receiving cavity 68, the distribution channel system 70, the buffer rings 91, 92, the increasing clearance 65 and conical clearance 67, and out the annular exit port 98. By this configuration, the layering material extruding from the annular exit port 98 is applied concentrically over the core material extruding from the exit port 63 and a concentrically layered composite POF, exiting through hole 33, may be producer.

In summary, a crosshead die has been described wherein the distribution path of the layering material through the crosshead is such that the linear travel or flow distance is substantially the same to the annular exit port. Because the flow paths are so arranged, uneven circumferential flow rate at the annular exit port is not experienced. Accordingly, the crosshead die according to the present invention avoids the problem of uneven wall thickness of the layering material while co-extruding a multilayered core POF.

Further, because the layering material is passed through buffer rings 91, 92, inner stresses that may be present in the layering material is stabilized. Although two buffer rings have been described, more or less buffer rings may be employed as needed to stabilize the material.

Moreover, the crosshead die configuration described herein advantageously provides the ability to easily modify the thickness of the layering material or the diameter of the POF core by simply changing the components therein. The thickness of the layering material is defined by the annular exit port 98, which is formed by the clearance between the die insert 32 and the body 28. Hence, the annular exit port 98 clearance may be controlled by simply assembling properly sized die insert 32 and body 28. If a change in the layering material thickness is desired, the die insert, for example, may be replaced with another that yields the desired clearance. In this way, the crosshead die according to the present invention facilitates easily modifying the structure of the POF and changing the optical properties of the extruded POF.

In a second embodiment, a crosshead die 20 is capable of extruding multiple layers simultaneously over a co-extruded core. FIG. 11 illustrates a fiber production system 40 comprising the crosshead die 20, a first extruder 12, a second extruder 13, a third extruder 15, a fiber drawing device 18 and fiber collection device 22.

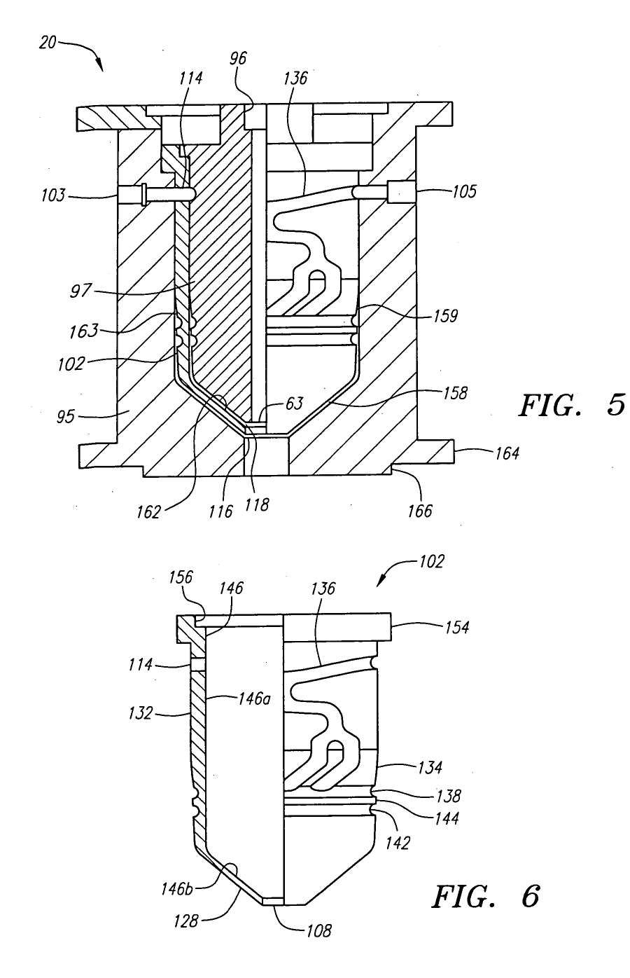

Referring to FIG. 5, the crosshead die 20 includes a body 95, an inner layer die insert 97 and an outer layer die insert 102. In this configuration, the body 95 and the inner layer die insert 97 generally have the same features as already described in the first embodiment. However, the body 95 includes two radial bores instead of one; an inner layer radial bore 103 and outer layer radial bore 105. Also, the internal diameters of the body 95 are sized to engage with the external features of the outer die insert 102, and the external diameters of the inner layer die insert 97 are sized to engage with the internal features of the outer layer die insert 102. Otherwise, the body 95 and inner layer die insert 97 include the features and elements already described for body 28 and die insert 32 as illustrated in FIGS. 3 and 4, respectively. Therefore, the same reference numerals representing those common features or elements will be referred herein.

The outer layer die insert 102 will now be described in greater detail and is independently illustrated in FIG. 6. The outer layer die insert 102 includes an exterior conical surface 128, an exterior cylindrical surface 132, a frustoconical surface 134, a mounting flange 154, a support counterbore 156, a distribution channel system 136, a first buffer ring 138, a second buffer ring 142 and a bridging surface 144. These exterior features are sized to fit within the interior surface 34 of the body 95. The internal features of the outer layer die insert 102 includes an interior bore 146 which has a generally cylindrical portion 146a and a conical surface 146b, a through hole 108, and a material supply radial bore 114.

Referring to FIG. 5, the physical relationship of the assembled crosshead die 20 will now be described. The outer layer die insert 102 is first inserted into body 95 and secured thereto at the insert support bore 39 using conventional fastening devices such as screws or bolts through mounting flange 154. Once secured in place, the conical surface 34b of the body 95 and the exterior conical surface 132 of the outer layer die insert 102 creates a conical clearance 158 which extends to an outer annular exit port 116. Similar to the manner already described herein, a gradually increasing clearance 159 is also created in the area adjacent to the frustoconical surface 134 of the outer die insert 102. The outer die insert 102 is oriented such that the outer layer radial port 105 of the body 95 is aligned to the receiving cavity and the distribution channel system 136. The radial bore 114 is also aligned with the inner layer radial bore 103 of the body 95.

The inner layer die insert 97 is then inserted into the interior bore 146 of the outer die insert 102 and secured thereto at the support counterbore 156 using conventional fastening devices such as screws or bolts through insert flange 51. Once secured, the conical surface 146b of the outer die insert 102 and the conical surface 62 of the inner die insert 97 form a conical clearance 162 which extends to an inner annular exit port 118. Similar to the manner already described herein, a gradually increasing clearance 163 is also created in the area adjacent to the frustoconical surface 61 of the inner die insert 97. The inner die insert 97 is also oriented so that it aligns with the inner layer material bore 103.

In use, a first mixed molten material (core material) is received at the core inlet 96 from the first extruder 12; a second mixed molten material (inner layer material) is received at the inner layer radial bore 103 from the second extruder 13; and a third mixed molten material (outer layer material) is received at the outer layer radial bore 105 from the third extruder 15. The core material travels through the axial bore of the inner die insert 97 and extrudes out of port 63. The inner and outer layer materials travel respectively through the separate distribution channels, the gradually increasing clearances, buffer rings and conical clearances to extrude out of the inner annular exit port 118 and outer annular exit port 116. As the inner and outer layers are extruded out of the respective annular exit ports over the core, a co-extruded multilayered core POF may be produced.

Although the crosshead die 102 includes two die inserts, more die inserts may be used in a like manner by adding die inserts similar to the outer die insert 102. However, because a POF generally has a very small diameter, controlling the tolerances and aligning the inserts is difficult. Accordingly, a crosshead die having two die inserts as illustrated in FIGS. 5 or 10 is preferred.

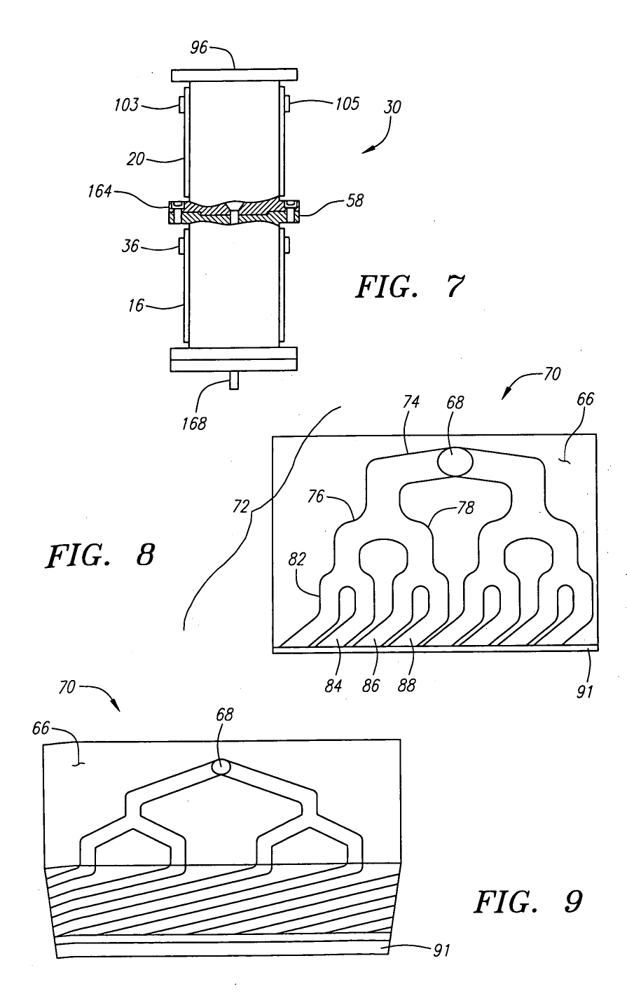

In a third embodiment, a crosshead die set 30 capable of producing a concentrically layered POF having greater number of layers is describe herein. Referring to FIG. 7, the crosshead die 16 or 20 may be serially attached to form a crosshead die set 30. For illustrative purposes, a crosshead die set 30 including a first crosshead die 20 and a second crosshead die 16 will be described herein.

Referring to FIGS. 5 and 7, the downstream end of the first crosshead die 20 includes a mounting flange 164 and an alignment plug 166. Referring to FIGS. 2 and 7, the upstream end of the second crosshead die 16 includes a mounting flange 58 and alignment counterbore 37. Controlling the alignment of the crosshead dies may be accomplished by tightly holding the tolerance of the alignment plug 166 and counterbore 37, the first crosshead die 20 can be secured to the second crosshead die 16 using bolts, screw or other conventional fastening methods.

In use, the first crosshead die 20 receives a core material at the core inlet 96, a first layering material at radial port 103, and a second layering material port 105. Under proper conditions, a first co-extruded POF having the core and the first and second layering material concentrically applied thereon is co-extruded from the first crosshead die 20. As the crosshead dies are arranged in series, this first co-extruded POF then travels through the axial bore 14 of the second crosshead die 16 wherein a third layering material is applied concentrically over the first co-extruded POF to form a second co-extruded POF 168. In this manner, the second co-extruded POF 168 exiting the crosshead die set 30 is produced having a multilayered core structure including three concentric layering materials.

Although a crosshead die set 30 comprising two crosshead dies capable of producing a three layer concentrically co-extruded POF has been described above, it is readily observed that additional crosshead dies may be assembled in series to add more layers to the co-extruded POF according to the present invention. Additionally, each crosshead die assembled to form the die set 30 may be a one layer crosshead die 16, two layer crosshead die 20, or other crosshead die configuration capable of applying numerous layers, in any combination.

Configured as described, the crosshead die set 30 provides the ability to easily add or remove layers to a co-extruded multilayered core POF by simply adding or removing a particular crosshead die. Advantageously, among other things, this configuration provides the flexibility to easily modify POF structures; the ability to maintain a layer-by-layer quality control over the POF; and the capacity to reduce tooling and inventory since individual crosshead dies may be separately replaced. Accordingly, retooling and inventory costs are minimized.

Furthermore, though the crosshead die configurations disclosed herein have been described to mount onto other crosshead dies, such a limitation is not necessary. The mounting flanges 54 and 58 of crosshead die 16 as illustrated in FIG. 2, and flange 164 of crosshead die 20 as illustrated in FIG. 5, may be configured to mount the crosshead die to any device, such as an extruder or support stand, as necessary to support a fiber production system.

Additional advantages and modifications will readily occur to those skilled in the art. The invention in its broader aspects is not, therefore, limited to the specific details, representative methods, and illustrative examples shown and described. Accordingly, departures may be made from such details without departing from the spirit and scope of applicant's general inventive concepts.

1. A crosshead die apparatus comprising:
a body having an exit port; and
a die insert;
wherein the die insert comprises a core extrusion element for extruding a core and a distribution channel system for distributing a layering material that is to be extruded over the core.

2. The apparatus of claim 1 wherein the distribution channel system comprises a plurality of channels.

3. The apparatus of claim 1 wherein the core extrusion element is a through bore.

4. The apparatus of claim 2 wherein the distribution channel system further comprises an annular buffer ring.

5. The apparatus of claim 2 wherein the distribution channel system further comprises two annular buffer rings.

6. The apparatus of claim 2 wherein the channels of the distribution channel system are helical and axial.

7. The apparatus of claim 1 wherein the distribution channel system is configured such that pressure drops do not occur as the layering material flows to the exit port.

8. The apparatus of claim 7 wherein the distribution channel system is-further configured to enhance mixing of the layering material prior to extrusion.

9. The apparatus of claim 8 wherein the distribution channel system is further configured such that the circumferential flow rate at the exit port is constant or even.

10. The apparatus of claim 9 wherein the distribution channel system is further configured to stabilize stresses present in the layering material during extrusion.

11. A crosshead die apparatus comprising:
a body having an exit port; and
at least two die inserts;
wherein at least one of the at least two die inserts comprises a core extrusion element for extruding a core and a distribution channel system for distributing a layering material that is to be extruded over the core.

12. The apparatus of claim 11 wherein the distribution channel system comprises a plurality of channels.

13. The apparatus of claim 11 wherein the core extrusion element comprises a through bore.

14. The apparatus of claim 12 wherein the distribution channel system further comprises an annular buffer ring.

15. The apparatus of claim 12 wherein the distribution channel system further comprises two annular buffer rings.

16. The apparatus of claim 12 wherein the channels of the distribution channel system are helical and axial.

17. The apparatus of claim 11 wherein the distribution channel system is configured such that pressure drops do not occur as the layering material flows to the exit port.

18. The apparatus of claim 17 wherein the distribution channel system is further configured to enhance mixing of the layering material prior to extrusion.

19. The apparatus of claim 18 wherein the distribution channel system is further configured such that the circumferential flow rate at the exit port is constant or even.

20. The apparatus of claim 19 wherein the distribution channel system is further configured to stabilize stresses present in the layering material during extrusion.

21. A method of manufacturing a fiber comprising extruding a core material and at least one layering material through a crosshead die apparatus to produce a fiber such that the fiber has a core and at least one layer extruded over the core, where in the crosshead die apparatus comprising:
a body having an exit port; and
a die insert;
wherein the die insert comprises a core extrusion element for extruding a core and a distribution channel system for distributing a layering material that is to be extruded over the core.

22. The method of claim 21 wherein the distribution channel system comprises a plurality of channels.

23. The method of claim 21 wherein the core extrusion element comprises a through bore.

24. The method of claim 22 wherein the distribution channel system further comprises an annular buffer ring.

25. The method of claim 22 wherein the distribution channel system further comprises two annular buffer rings.

26. The method of claim 22 wherein the channels of the distribution channel system are helical and axial.

27. The method of claim 21 wherein the distribution channel system is configured such that pressure drops do not occur as the layering material flows to the exit port.

28. The method of claim 27 wherein the distribution channel system is further configured to enhance mixing of the layering material prior to extrusion.

29. The method of claim 28 wherein the distribution channel system is further configured such that the circumferential flow rate at the exit port is constant or even.

30. The method of claim 29 wherein the distribution channel system is further configured to stabilize stresses present in the layering material during extrusion.

31. A system of manufacturing a multilayer fiber that facilitates ease in modifying the system comprising:
at least two crosshead dies in series further configured so that any one of the at least two crosshead dies can be easily removed or changed or so that additional crosshead dies can be added to the system;
wherein each crosshead die applies a layer to the fiber; and
wherein a fiber extruded from an upstream crosshead die having at least one layer extruded by that crosshead die is then fed into an adjacent downstream crosshead die which applies an additional layer.

32. The system of claim 31 wherein at least one of the at least two crosshead dies comprises a core extrusion element for extruding the core and a distribution channel system for distributing the layering material that is to be extruded over the core.

33. The system of claim 32 wherein the distribution channel system comprises a plurality of channels.

34. The system of claim 32 wherein the core extrusion element comprises a through bore.

35. The system of claim 33 wherein the distribution channel system further comprises an annular buffer ring.

36. The system of claim 33 wherein the distribution channel system further comprises two annular buffer rings.

37. The system of claim 33 wherein the channels of the distribution channel system are helical and axial.
